(19) United States
(12) Patent Application Publication
(10) Pub. No.: US 2025/0303631 A1
(43) Pub. Date: Oct. 2, 2025

(54) METHOD FOR REGULATED HEATING OF A SUCCESSION OF PREFORMS

(71) Applicant: SIDEL PARTICIPATIONS, Octeville-sur-Mer (FR)

(72) Inventors: Mikael DERRIEN, OCTEVILLE-SUR- MER (FR); Mickaël LETESTU, OCTEVILLE-SUR- MER (FR)

(21) Appl. No.: 19/092,022

(22) Filed: Mar. 27, 2025

(30) Foreign Application Priority Data
Mar. 28, 2024 (FR) FR2403176

(51) Int. Cl. B29C 49/78; B29C 49/64; B29L 31/00

(52) U.S. Cl. CPC B29C 49/786; B29C 49/6418; B29C 2049/78675; B29C 2049/78805; B29L 2031/712

(57) ABSTRACT

Provided is a method for heating a succession of preforms. The method includes heating a body of a first preform using two heating elements that each heat a heated area of the body. The method includes determining a target heating temperature for each heated area according to the container to be produced, measuring the temperature of one of the heated areas of the body upon completion of the heating step, and modifying the heating power of the heating element corresponding to the heated area of the body if the measured temperature of the heated area is different from the target heating temperature. The method further includes heating the body of the other preforms of the succession of preforms with the modified heating power.

### CROSS-REFERENCE TO RELATED APPLICATIONS

This application claims the benefit of French Application No. FR2403176, filed Mar. 28, 2024, the entire contents of which is hereby incorporated herein by reference.

### BACKGROUND

The present invention concerns a method for heating of a succession of preforms for the production of containers by deformation of the said heated preforms.

It is known to heat the preforms in a container production installation in order to make these preforms malleable and permit their subsequent deformation, for example by stretch blow-molding, in order to produce containers from the heated preforms.

For this purpose, a succession of preforms is for example circulated in a heat treatment unit, or furnace, in which the preforms pass in front of heating elements. The heating elements are in particular distributed according to the height of the body of the preforms, i.e. substantially parallel to the preform axis along which the body of the preforms extends, in order to make it possible to heat to controlled temperatures a plurality of areas of the body of the preforms distributed along the height of the preforms. In fact, these areas must be able to be heated to different temperatures in order to control the deformation of these areas as well as possible during the production of a container, according to the form required for this container. Thus, the higher the temperature of an area, the more this area can be deformed during the production of the container. The heating power levels of the different heating elements thus make it possible to apply a profile of temperatures to a preform, with this profile depending on the characteristics of the container to be produced from this preform, and on the material of the preform.

In order to ensure correct heating of the preforms, it is known to put into place a regulation loop, in which the regulation of the heating power of the heating elements is subject to the temperature of preforms heated, measured in an area of the preform upon completion of the heating of the preforms. The distribution of the heat in the preform is determined according to the measurement of a reference temperature measured in an area of the preform, and the heating power of the heating elements is adjusted according to this reference temperature, in order to approach the profile of temperatures to be applied to the preforms.

However, a regulation loop of this type does not give complete satisfaction. In fact, in particular for areas of the preform which are distant from the area in which the reference temperature has been measured, the regulation of the heating power continues to be based on this reference temperature, which makes the regulation approximate.

### SUMMARY

One of the objectives of the invention is to eliminate these disadvantages by proposing a method for heating of a succession of preforms, wherein the heating power of the heating elements can be adjusted precisely, in order to apply a profile of temperatures corresponding precisely to the profile required for the preforms during their heating.

For this purpose, the invention concerns a method for heating of a succession of preforms for the production of containers by deformation of the said heated preforms, each preform comprising a body extending along a preform axis, the said heating method comprising the following steps:
heating the body of a first preform of the succession of preforms by means of at least two heating elements, with each heating element heating a different heated area of the body of the first preform along the preform axis;
determining at least one target heating temperature for each heated area of the body of each preform, according to the container to be produced by deformation of each heated area of the preform;
measuring the temperature of at least one of the heated areas of the body of the first preform upon completion of the heating step;
modifying the heating power of the heating element corresponding to the said heated area of the body, if the temperature measured of the said heated area is different from the target heating temperature, the said heating power being modified in order for the temperature of the corresponding heated area of the preform to be substantially equal to the target heating temperature;
heating the body of the other preforms of the succession of preforms with the modified heating power.

In the heating method according to the invention, the heating power of each heating element is thus regulated according to the temperature measured in the area of the body of the corresponding preform which this heating element is designed to heat. In other words, the heating power of a heating element is regulated on the basis of a real measurement of the temperature in the heated area of the body of the preform, which is heated by this heating element, and is not based on a reference temperature measured in a different area of the body of the heated preform. The regulation loop thus established therefore makes it possible to regulate precisely the heating power of the heating elements.

The heating method according to the invention can also comprise one or more of the following characteristics, taken in isolation or according to any combination which can technically be envisaged:
the temperature is measured for each heated area of the body of the first preform, the heating power of each heating element corresponding to each heated area being modified according to the temperature measured of each heated area and to the target heating temperature of each heated area;
the body of each preform comprises at least three areas which are heated by at least three heating elements, at least two adjacent heated areas along the preform axis of the said heated areas being grouped together in order to form at least one extended heated area, the heating power levels of the heating elements corresponding to the said extended heated area being modified together according to the temperature measured of one of the heated areas of the said extended heated area and to a target heating temperature of the said extended heated area;
the power of the heating elements corresponding to the said extended heated area is different from the heating power of the heating element corresponding to the heated area outside the extended heated area;
the target heating temperature of the heated area is between a low acceptable heating temperature and a high acceptable heating temperature, with the heating power of the heating element corresponding to the said heated area being modified so that the temperature of the said heated area is between the said low acceptable heating temperature and the said high acceptable heating temperature upon completion of the heating step;
the difference between the lower acceptable heating temperature and the target heating temperature, and the difference between the target heating temperature and the high acceptable heating temperature are the same or different;
each heated area of the body of a preform is heated by a plurality of heating elements which are adjacent in a direction of passage substantially perpendicular to the preform axis, the said preform being displaced in the said direction of passage facing the said plurality of heating elements during the heating step, with the heating power of the series of the said adjacent heating elements being modified so that the temperature of the corresponding heated area is substantially equal to the target heating temperature upon completion of the heating step;
each heating element comprises a plurality of sources of monochromatic or pseudo-monochromatic electromagnetic radiation;
the temperature of at least one of the heated areas is measured by at least one thermal camera;
each heated area extends over a height, measured along the preform axis, of between 4 mm and 5 mm;
the heating method also comprises a step of measurement of the thickness of the wall of a deformed area in a container produced from a preform out of the succession of preforms, with the said deformed area corresponding to at least one heated area of the preform from which the container is produced, with the heating power of the heating element corresponding to the said heated area being modified if the thickness measured is different from a target thickness for the said deformed area.

### BRIEF DESCRIPTION OF THE DRAWINGS

The invention will become more apparent from reading the following description, provided purely by way of non-limiting example, with reference to the drawings in which:

FIG. 1 is a schematic representation from above of an installation for production of containers making it possible to implement the heating method according to the invention;

FIG. 2 is a schematic representation in cross-section of a preform heated by heating elements;

FIG. 3 is a schematic representation of an interface for implementation of the heating method according to the invention; and

FIG. 4 is a schematic representation of a part of a container produced from a preform heated according to a heating method of the invention for implementation of an optional additional step of the heating method.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere. Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

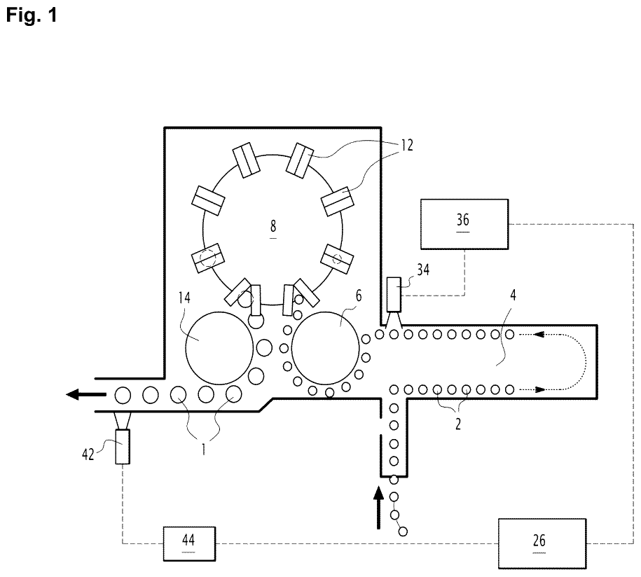

With reference to FIG. 1, a description is provided of an installation for production of containers 1 from a succession of preforms 2. An installation of this type comprises, in a known manner and in the order of circulation of the preforms 2 and the containers 1 in the installation, a heat treatment unit 4, or furnace, a transfer wheel 6, and a forming station 8.

The heat treatment unit 4 is designed to heat a succession of preforms 2 transported in the heat treatment unit 4 by a system for grasping and displacement of the preforms 2, such as to make them pass in front of the heating elements 10, as will be described in greater detail hereinafter. It is however understood that the invention also applies to a heat treatment unit 4 which makes it possible to heat each preform 2 individually, without displacing it in the heat treatment unit 4.

At the output from the heat treatment unit 4, the transfer wheel 6 is designed to recuperate the heated preforms 2, and to transfer them to the forming station 8.

The forming station 8 is for example formed by a carousel bearing a plurality of molds 12 forming molding cavities with the form of the containers 1 to be produced. The heated preforms 2 are each placed in a mold and deformed in order to acquire the form of a container 1, for example by stretch blow-molding. At the output from the forming station, the formed containers 1 are recuperated for example by means of another transfer wheel 14, for example in order to be conveyed to other stations of the installation, such as a labeling station, a filling station, and a station for putting a stopper into place on the containers.

As previously indicated, an installation of this type is known, and will not be described in greater detail here. It is however understood that the arrangement of the installation represented in FIG. 1 is provided purely by way of example, and that the invention applies to any type of arrangement of installation, provided that it comprises a heat treatment unit 4.

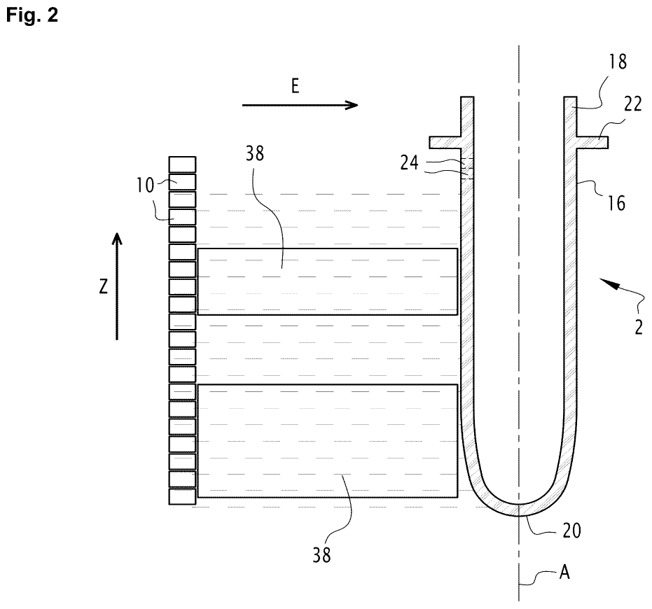

As represented more particularly in FIG. 2, each preform 2 comprises a body 16 and a neck 18, and the heat treatment unit 4 is designed to heat the body 16 without heating the neck 18 of each preform 2, as will be described in greater detail hereinafter. The body 16 extends along a preform axis A, and has for example the form of a test tube extending between a base 20 and the neck 18, which forms an open end of the test tube. The neck 18 comprises for example a flange 22 extending from a radial plane substantially perpendicularly to the preform axis A projecting towards the exterior of the body 16. A flange 22 of this type forms for example a surface for grasping of the preform 2 and of the container 1, produced from the preform 2. The part of the preform 2 extending from the flange 22 as far as the open end comprises for example a thread which makes it possible to secure a stopper on the container 1 produced from the preform 2. Thus, the neck 18 of the preform 2 has the same form as the neck of the container 1 produced from this preform 2. For this reason, it is necessary not to heat the neck 18 of the preform 2 in the heat treatment unit 4, in order to avoid any deformation of the neck 18.

The heat treatment unit 4 is designed to heat the body 16 of each preform 2, so as to increase the temperature of the body 16 to above the vitreous transition temperature of the material forming the body 16, such that the body 16 acquires a malleable nature which permits its deformation in order to form a container 1.

For this purpose, and as represented in FIG. 2, the plurality of preforms 2 is designed to circulate facing at least two heating elements 10, which are designed to emit thermal radiation towards the body of the preforms 2 passing in front of them. More particularly, the heating elements 10 are positioned on top of one another in a direction of elevation Z of the heat treatment unit 4, substantially parallel to the preform axis A, when a preform 2 is placed in the heat treatment unit 4. Thus, the heating elements 10 are positioned such as to expose all of the body 16 of the preforms 2 to the radiation, more particularly from the base 20 to the flange 22 of the preforms 2. Each heating element 10 is more particularly designed to heat an area, known as the heated area 24, of the body 16 of a preform 2, with the heated area 24 extending over part of the height of the body of the preform 2, measured along the preform axis A. In other words, the body 16 of each preform 2 comprises at least two heated areas 24 positioned one above the other along the preform axis A, with each heated area 24 extending facing a corresponding heating element 10, such as to be exposed to the heat emitted by this corresponding heating element 10, when the preform 2 is circulating in the heat treatment unit 4.

Each heating element 10 comprises for example a plurality of sources of monochromatic or pseudo-monochromatic electromagnetic radiation. More particularly, each heating element 10 is for example a laser emitter, and the sources of radiation are laser chips designed to emit laser radiation in the infrared field in a direction of emission E which is substantially perpendicular to the direction of elevation Z, and corresponds to the direction separating the heating elements 10 from the body 16 of the preforms 2 circulating in the heat treatment unit 4. The sources of radiation are for example arranged next to one another on a support, so as to form at least one row of sources of radiation extending in the longitudinal direction. According to one embodiment, the sources of radiation form at least one upper row and at least one lower row positioned one above the other in the direction of elevation.

Such heating elements are for example described in the document FR 3 124 030 and persons skilled in the art will be able to refer to that document to obtain more details, notably as regards the structure of each source of radiation, the arrangement of the sources of radiation on a support, the connection of the sources of radiation to one another, and the cooling of the heating elements. It is understood that the invention is not limited to heating elements formed by laser emitters and also applies to other types of heating element, such as tubular incandescent lamps of the halogen type.

It should however he noted that the invention is particularly suitable for laser emitters, since laser emitters of this type emit radiation which is very low-dispersion, i.e. oriented mainly in the direction of emission E, unlike halogen heating elements which have a radiation emission cone which is particularly large. Thus, the laser emitters make it possible to heat a highly localized heated area 24 of the body 16 of the preform 2, whereas a halogen heating element will heat a more extensive area, and the radiation emitted by this heating element, and/or the reflection of this radiation in the heat treatment unit 4, is/are liable to interfere with the radiation emitted by another heating element, and thus heat a heated area other than the one for which it is intended, which reduces the efficiency of the heating method which will be described hereinafter.

With laser emitters of this type, each heated area 24 has for example height substantially of between 4 mm and 5 mm, for example substantially equal to 4.7 mm. According to one embodiment, a preform 2 has between eighteen and thirty six heated areas 24, with the heat treatment unit 4 comprising at least that number of heating elements 10 arranged in a column extending in the direction of elevation Z, with each heating element 10 of the column being designed to heat one of the corresponding heated areas 24 according to the height of the body 16 of the preforms 2.

According to one embodiment, the heat treatment unit comprises a plurality of columns of heating elements 10, positioned adjacent to one another in the direction of circulation of the preforms 2 in the heat treatment unit 4, such that the preforms pass in front of a succession of heating elements 10 when they circulate in the heat treatment unit 4. In other words, a heated area 24 of the body 16 of a preform 2 is heated by a plurality of heating elements 10 extending to the same height in the direction of elevation Z, while the preform 2 circulates in the heat treatment unit 4. According to one embodiment the preform 2 is also rotated around itself about its preform axis A, while it is in the heat treatment unit 4, such that the entire circumference of the body 16 is exposed to the radiation of the heating elements 10. Thus, each heated area 24 extends around the entire circumference of a portion of the body 16 of each preform 2. However, as will be described hereinafter, in the case of an asymmetrical deformation of the body 16 of the preform 2 in a heated area 24, the temperature of this heated area 24 is not uniform around the entire circumference of the preform.

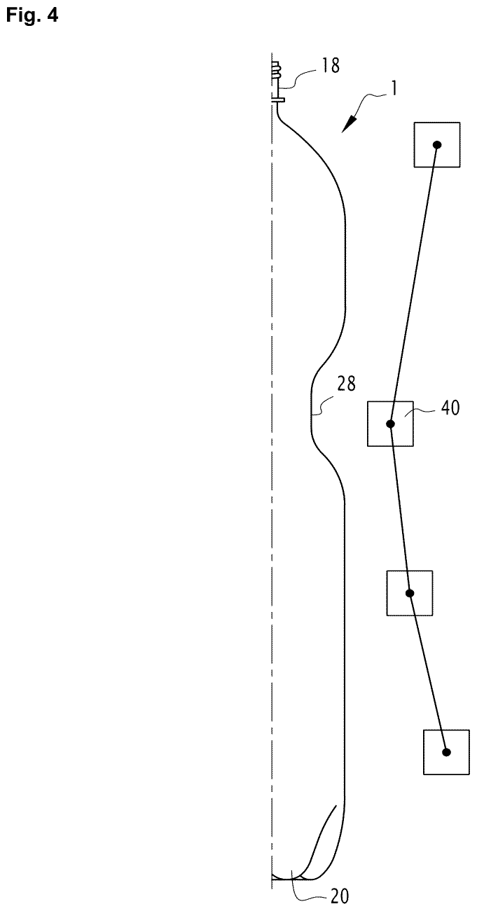

The heating power of each heating element 10 is adjustable by means of a device 26 for controlling the heat treatment unit 4. The control device 26 thus makes it possible to adjust the intensity of the heating of each heated area of the preform 2, in order to control the temperature profile which is applied to it. In fact, in a known manner, the heated areas 24 of a single preform 2 are not necessarily heated to a uniform temperature. The temperature of a heated area 24 depends in particular on the form of the container 1 to be produced from the preform 2. More particularly, the more a given area of a preform 2 must be deformed, or stretched, in order to form the container 1, the higher the temperature to which it must be heated is. Thus, with reference to the example of the form of the container 1 represented in FIG. 4, the areas of the body 16 extending in the vicinity of the neck 18, and the areas of the body extending in the vicinity of the base 20 must be heated to a higher temperature than that which is necessary for the areas extending at the contraction 28 extending substantially halfway up the container 1.

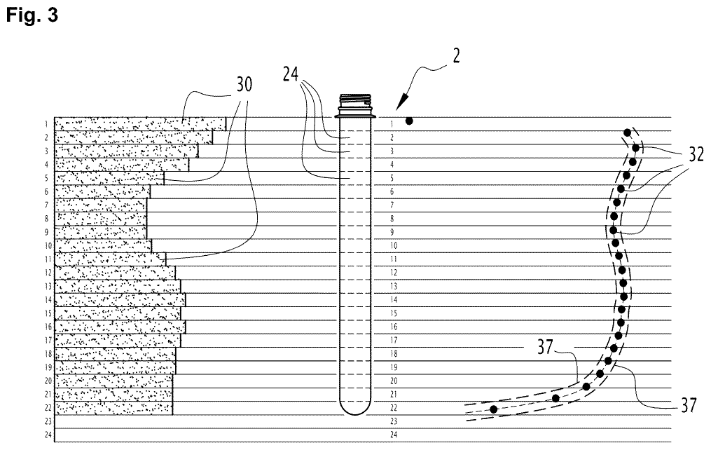

As represented in FIG. 3, the control device 26 thus makes it possible to adjust the heating power of a particular heating element 10, as represented by the histogram on the left in FIG. 3, according to the temperature to which the heated area 24 corresponding to this particular heating element 10 must be heated, as represented in the graph on the right in FIG. 3. In this figure, showing an example of a display of the regulation applied by the control device 26 to the heating elements, there are twenty four heating elements 10, which are numbered from 1 to 24, and bars 30 of the histogram each represent the heating power of one of these heating elements 10 according to the heated area 24 of the preform 2, facing these heating elements 10. In FIG. 3, the body of the preform 2 comprises twenty-two heated areas 24. In the graph on the right, each dot 32 represents the required temperature, known as the target heating temperature, for the corresponding heated area 24. By observing this figure, it can thus be seen that the higher the target heating temperature of a heated area 24, the greater the heating power of the corresponding heating element 10 is. In the example of FIG. 3, it can be seen for example that the heating power of the heating elements 6 to 10 is substantially lower than the heating power of the other heating elements, which makes it possible to produce the contraction 28 of the container 1 represented in FIG. 4.

When the heat treatment unit 4 comprises a plurality of columns of heating elements 10, the heating power of the heating elements 10 of a single line, i.e. the heating elements 10 extending along the height in the direction of elevation Z, is constant. Thus, when the control device 26 controls the heating power of a particular heating element 10, this heating power is applied to all the heating elements 10 situated at the same height as this particular heating element. However, in the case when the container 1 to be formed has at least one portion in which the cross-section is not circular, the heating power of the heating elements 10 situated at the height of this portion can be modulated in order to permit an asymmetrical deformation of the preform 2 in this portion.

In the heating method according to the invention, the preforms pass into the heat treatment unit 4 facing the heating elements 10, the heating power of which is regulated by the control device 26 according to the target heating temperature for the corresponding heated areas 24.

The heating method also comprises a loop for regulation of the heating power of each heating element 10 according to the real temperature of the corresponding heated area 24.

For this purpose, the heating method comprises a step of measurement of the temperature of at least one heated area 24 of at least a first preform 2 of the succession of preforms 2, after the heating thereof. For this purpose, the heat treatment unit 4 comprises a device 34 for measurement of the temperature of at least one heated area 24 in the vicinity of the output of the heat treatment unit 4. Preferably, the measurement device 34 is designed to measure the temperature of each heated area 24 of a preform 2 which has been heated by the corresponding heating elements 10 of the heat treatment unit 4. A measurement device 34 of this type is for example formed by a thermal camera arranged at the output of the heat treatment unit, and acquiring an image, for example in the infrared field, of each heated preform 2, transmitted to the transfer wheel 6, as represented in FIG. 1. As a variant, the measurement device 34 comprises one or more pyrometers each designed to measure the temperature of a heated area 24 of the body 16 of at least the first preform 2. The temperatures are acquired by a processing device 36 of the measurement device 34, and are transmitted to the control device 26.

The control device 26 compares the temperature measured for at least one heated area 24 with the target heating temperature for this heated area. If the temperature measured is substantially equal to the target heating temperature, the control device 26 does not modify the heating power of the heating element 10 corresponding to this heated area. If the temperature measured is different from the target heating temperature, the control device 26 modifies the heating power of the corresponding heating element 10, in order for the heated area 24 to be heated to the target temperature required. It should be noted that “substantially equal to” and “different from” mean that the temperature measured is or is not situated in an acceptable range around the target heating temperature, as represented by the two curves 37 in broken lines represented around the dots 32 on the right-hand graph of FIG. 3. In other words, the target heating temperature is situated between a low acceptable heating temperature, lower than the target heating temperature, and a high acceptable heating temperature, higher than the target heating temperature. If the temperature measured is between these two acceptable heating temperatures, then the control device 26 considers that the temperature measured is substantially equal to the target heating temperature, and does not modify the heating power of the corresponding heating element 10. Conversely, if the temperature measured is lower than the low acceptable heating temperature, the control device 26 considers that the temperature measured is different from the target heating temperature, and increases the heating power of the corresponding heating element 10. If the temperature measured is higher than the high acceptable heating temperature, the control device 26 considers that the temperature measured is different from the target heating temperature, and reduces the heating power of the corresponding heating element 10. According to one embodiment, the acceptable heating temperatures correspond to more or less 2% of the target heating temperature. It should be noted that the two curves 37 of acceptable heating temperatures are not necessarily symmetrical with one another in relation to the target heating temperatures. In other words, the difference between the low acceptable heating temperature and the target heating temperature and the difference between the target heating temperature and the high acceptable heating temperature can be different from one another.

The regulation thus makes it possible to adjust the heating power of a particular heating element 10 (or of a line of heating elements 10 rising to the same height) according to the temperature measured for the heated area 24 by this heating element 10, and not according to a reference temperature measured in another heated area of the preform. Thus, the regulation is considerably improved and more precise.

Preferably, the above-described regulation is applied to all the heated areas 24 of the body 16 of the first preform 2, such as to regulate all the corresponding heating elements 10, as represented in FIG. 3. Thus, each heating element 10 can be regulated according to the temperature measured for the corresponding heated area 24, which makes this regulation particularly precise.

Also preferably, the steps described above are applied to all the preforms 2 of the succession of preforms 2, in order to apply the regulation continuously as the preforms 2 are heated in the heat treatment unit. This therefore ensures that the required temperature profile is applied to all the preforms 2, and that any divergence can be corrected without stopping the heat treatment unit 4.

According to one embodiment, the method can be optimized by applying similar regulation to one or more groups of heating elements 10, from the measurement of the temperature of a heated area 24 by one of the heating elements 10 of the or each group of heating elements 10. In fact, as can be seen in FIG. 3, in certain cases, a plurality of adjacent heated areas 24 must be heated in a similar manner since these heated areas 24 are intended to be deformed in order to form a particular area of the container during the production of a container 1. Thus, in FIG. 3, the heated areas 24 which are numbered from 7 to 9 must for example be heated by the same heating power in order to form the contraction 28 of the container 1 of FIG. 4. Similarly, the heating power of the heating elements 10 numbered from 20 to 22 must be the same in order to form the base of the container 1. A step of this type of grouping of heated areas 24 can be implemented since the body of the preform comprises at least three heated areas 24, two adjacent areas of which along the axis of the preform A are grouped together in order to form an extended heated area 38.

In this case, the heating method comprises the grouping together of at least two adjacent heated areas 24, in order to form an extended heated area 38 represented by rectangles in FIG. 2. The regulation can thus be applied to the or each extended heated area 38, at the same time as the regulation for heated areas 24 outside an extended heated area, by modifying together and in the same way (increase of the heating power or decrease of the heating power) the heating power levels of the heating elements 10 corresponding to each extended heated area 38, according to the temperature measured of one of the heated areas 24 of the or each extended heated area 38 and a target heating temperature of the or each extended heated area 38. It is understood that the heating power of the heating elements 10 corresponding to an extended heating area 38 can be different from the heating power 10 of the heating elements corresponding to a heated area 24 outside this extended heating area 38, and/or corresponding to another extended heated area 38. For example, the heated areas 24 of an extended heated area 38 are designed to be deformed in a similar manner in order to form a container 1.

According to one embodiment, the heating method also comprises regulation of the heating power of the heating elements 10 according to the thickness of the wall of the containers 1 produced from the heated preforms 2.

For this purpose, the heating method comprises a step of measurement of the thickness of the wall of a deformed area 40 in a container produced from a preform of the succession of preforms, as represented in FIG. 4. This deformed area 40 corresponds to at least one heated area 24 of a preform 2 from which the container 1 is produced, and it is thus possible to provide the association between the thickness measured and the heating power 10 corresponding to the heated area 24 from which the deformed area 40 is formed. A comparison between the thickness measured and a target thickness of the deformed area thus allows the control device 26 to modify the heating power of the corresponding heating element 10, when the thickness measured is different from the target thickness, in the same way as for the comparison between a temperature measured and a target heating temperature previously described.

The thickness is for example measured by a device 42 for measurement of the thickness placed at the output of the forming station 8, or downstream from the other transfer wheel 14, as represented in FIG. 1. The thicknesses are acquired by a device 44 for processing of the device 42 for measurement of the thickness, and are transmitted to the control device 26 in order to put the regulation loop into place. As for the regulation based on temperatures measured, the regulation based on the thicknesses measured is preferably carried out on all of the deformed areas 40 corresponding to the heated areas 24, and thus to the heating elements 10. Similarly, extended deformed areas can be formed from adjacent deformed areas 40, in order to regulate the heating power of a plurality of heating elements 10 from a measurement of the thickness of a deformed area 40 of an extended deformed area. For details of the implementation of the regulation based on the measurement of thicknesses, reference can be made to the description provided for the regulation based on the measurement of temperatures.

The control device 26, the device 36 for processing of the device 34 for measurement of the temperature, and optionally the device 44 for processing of the device 42 for measurement of thickness are able to implement a heating method as described above.

These devices are electronic circuits which are designed to manipulate and/or transform data represented by electronic or physical quantities in registers of the devices and/or memories into other similar data, corresponding to physical data in the memories of registers or other types of display devices, transmission devices or storage devices.

As specific examples, the devices for control 26 and processing 36, 44 are produced in the form of a programmable logic component such as FPGA (Field Programmable Gate Array), or also an integrated circuit such as an ASIC (Application Specific Integrated Circuit).

As a variant, when the method is implemented in the form of one or more types of software, i.e. in the form of a computer program, also known as a computer program product, it can additionally be recorded on a support, not represented, which can be read by a computer. The support which can be read by a computer is for example a medium which can store electronic instructions, and can be coupled to a bus of a data system. By way of example, the support which can be read is an optical disk, a magneto-optical disk, a ROM memory, a RAM memory, any type of non-volatile memory (for example FLASH or NVRAM), or a magnetic board. A computer program comprising software instructions is then stored on the support which can be read.

We claim:

1. A method for heating of a succession of preforms for the production of containers by deformation of the said heated preforms, each preform comprising a body extending along a preform axis, the method comprising the following steps:
heating the body of a first preform of the succession of preforms with at least two heating elements, with each heating element heating a different heated area of the body of the first preform along the preform axis;
determining at least one target heating temperature for each heated area of the body of each preform, according to the container to be produced by deformation of each heated area of the preform;
measuring the temperature of at least one of the heated areas of the body of the first preform upon completion of the heating step;
modifying a heating power of the heating element corresponding to the said heated area of the body if the temperature measured of the said heated area is different from the target heating temperature, the heating power being modified in order for the temperature of the corresponding heated area of the preform to be substantially equal to the target heating temperature; and
heating the body of the other preforms of the succession of preforms with the modified heating power.

2. The method according to claim 1, wherein the body of each preform comprises at least three areas which are heated by at least three heating elements, wherein at least two adjacent heated areas along the preform axis of the said heated areas are grouped together in order to form at least one extended heated area, wherein the heating power levels of the heating elements corresponding to the extended heated area are modified together according to the temperature measured of one of the heated areas of the said extended heated area and are modified to the target heating temperature of the said extended heated area.

3. The method according to claim 1, wherein the heating power of the heating elements corresponding to the said extended heated area is different from the heating power of the heating element corresponding to the heated area outside the extended heated area.

4. The method according to claim 1, wherein the target heating temperature of the heated area is between a low acceptable heating temperature and a high acceptable heating temperature, with the heating power of the heating element corresponding to the said heated area being modified so that the temperature of the heated area is between the low acceptable heating temperature and the high acceptable heating temperature upon completion of the heating step.

5. The method according to claim 4, wherein a difference between the low acceptable heating temperature and the target heating temperature, and a difference between the target heating temperature and the high acceptable heating temperature are the same.

6. The method according to claim 4, wherein a difference between the low acceptable heating temperature and the target heating temperature, and a difference between the target heating temperature and the high acceptable heating temperature are different.

7. The method according to claim 1, wherein the heating elements are adjacent in a direction of passage substantially perpendicular to the preform axis,
wherein the preform is displaced in the direction of passage facing the heating elements during the heating step,
wherein the heating power of adjacent heating elements is modified so that the temperature of the corresponding heated areas is substantially equal to the target heating temperature upon completion of the heating step.

8. The method according to claim 1, wherein each heating element comprises a plurality of sources of monochromatic or pseudo-monochromatic electromagnetic radiation.

9. The method according to claim 1, wherein the temperature of at least one of the heated areas is measured by at least one thermal camera.

10. The method according to claim 1, wherein each heated area extends over a height, measured along the preform axis, of between 4 mm and 5 mm.

11. The method according to claim 1, further comprising a step of measurement of the thickness of the wall of a deformed area in a container produced from one of the preforms in the succession of preforms, wherein the deformed area corresponds to at least one heated area of the preform from which the container is produced, with the heating power of the heating element corresponding to the said heated area being modified if the thickness measured is different from a target thickness for the said deformed area.
